(19) United States
(12) Patent Application Publication
(10) Pub. No.: US 2024/0147443 A1
(43) Pub. Date: May 2, 2024

(54) COEXISTENCE IN TELECOMMUNICATION SYSTEMS

(71) Applicant: Nokia Technologies Oy, Espoo (FI)

(72) Inventors: Esa Tapani TIIROLA, Oulu (FI); Jorma Johannes KAIKKONEN, Oulu (FI); Man Hung NG, Swindon (GB)

(21) Appl. No.: 18/492,375

(22) Filed: Oct. 23, 2023

(30) Foreign Application Priority Data
Oct. 28, 2022 (FI) 20225963

(51) Int. Cl. H04W 72/0453

(52) U.S. Cl. CPC H04W 72/0453

(57) ABSTRACT

A device for adjusting a configuration of a user equipment includes a memory and processing circuitry configured to cause the device to receive, from a transmitter, a trigger to change a bandwidth configuration that is used as a reference for radio frequency transmission and reception requirements of the device, determine whether a target bandwidth indicated by the trigger involves a change of a reference channel, configure a radio frequency in response to determining that the target bandwidth involves the change of the reference channel, and reconfigure the bandwidth configuration based on the trigger.

### CROSS REFERENCE TO RELATED APPLICATION

This application claims priority to, and the benefit of, Finland application No. 20225963 filed 28 Oct. 2022, which is incorporated herein by reference in its entirety.

### TECHNICAL FIELD

One or more example embodiments relate to wireless communications networks.

### BACKGROUND

In the upcoming new radio (NR) release, NR Rel-18, new technologies including flexible duplexing and narrowband (NB) NR have been proposed. 5G-Advanced is a commercial term for technologies related to NR Rel-18 and beyond.

### SUMMARY

The scope of protection sought for various example embodiments is set out by the independent claims. The example embodiments and/or features, if any, described in this specification that do not fall under the scope of the independent claims are to be interpreted as examples useful for understanding various embodiments.

In the event of flexible duplexing and/or NB NR being deployed (e.g., soft deployed), difficult coexistence situations may occur. Example embodiments provide methods and apparatuses for reducing or minimizing co-channel and/or adjacent channel interference with regard to 5G-Advanced and/or 6G technologies.

At least one example embodiment provides a device including a memory and processing circuitry configured to cause the device to receive, from a transmitter, a trigger to change a bandwidth configuration that is used as a reference for radio frequency transmission and reception requirements of the device, determine whether a target bandwidth indicated by the trigger involves a change of a reference channel, configure a radio frequency in response to determining that the target bandwidth involves the change of the reference channel, and reconfigure the bandwidth configuration based on the trigger.

The processing circuitry is further configured to cause the device to transmit a user equipment capability to the transmitter.

The processing circuitry is further configured to cause the device to receive, from the transmitter, the bandwidth configuration of the device. The bandwidth configuration includes at least one parameter associated with the reference channel.

The processing circuitry is further configured to cause the device to reconfigure the radio frequency by selecting a channel bandwidth according to the change of the bandwidth configuration, and adjusting a radio frequency location based on the channel bandwidth.

The processing circuitry is further configured to cause the device to reconfigure the radio frequency and reconfigure the bandwidth configuration during a switching gap.

The processing circuitry is further configured to cause the device to receive a synchronization signal, from the transmitter, after the switching gap.

The bandwidth configuration may be for at least one of uplink or downlink communication.

The processing circuitry is further configured to cause the device to adjust a radio frequency size based on the channel bandwidth.

The bandwidth configuration includes a bandwidth part configuration.

The reference channel is a reference for at least one of transmission or reception requirements for the device.

The processing circuitry is further configured to cause the device to reconfigure the bandwidth configuration without configuring the radio frequency in response to determining that the target bandwidth does not involve a change of the reference channel.

The processing circuitry is further configured to cause the device to reconfigure the bandwidth without a switching gap in response to determining that the target bandwidth does not involve a change of the reference channel.

The capability is a capability for adjusting a channel bandwidth that is used as a reference for at least one of the transmit or the receive requirements.

At least one example embodiment provides a device comprising a memory and processing circuitry configured to cause the device to transmit, to a user equipment, a trigger to change a bandwidth configuration of the user equipment, receive, from the user equipment, an updated radio frequency in response to a target bandwidth indicated by the trigger involving a change of a reference channel, and transmit, to the user equipment, a synchronization signal according to the updated radio frequency.

The processing circuitry is further configured to cause the device to transmit the synchronization signal after a switching gap.

The processing circuitry is further configured to cause the device to receive a user equipment capability from the user equipment.

The processing circuitry is further configured to cause the device to transmit, to the user equipment, the bandwidth configuration of the user equipment. The bandwidth configuration includes at least one parameter associated with the reference channel.

The bandwidth configuration is for at least one of uplink or downlink communication.

The bandwidth configuration includes a bandwidth part configuration.

The reference channel is a reference for at least one of transmission or reception requirements for the user equipment.

At least one example embodiment provides a device for adjusting a configuration of a user equipment, the device includes a means for receiving, from a transmitter, a trigger to change a bandwidth configuration that is used as a reference for radio frequency transmit and receive requirements of the user equipment, a means for determining whether a target bandwidth indicated by the trigger involves a change of a reference channel, a means for configuring a radio frequency in response to determining that the target bandwidth involves the change of the reference channel, and a means for reconfiguring the bandwidth configuration based on the trigger.

At least one example embodiment provides a device for adjusting a configuration of a user equipment, the device including a means for transmitting, to the user equipment, a trigger to change a bandwidth configuration of the user equipment, a means for receiving, from the user equipment, an updated radio frequency in response to a target bandwidth indicated by the trigger involving a change of a reference channel, and a means for transmitting, to the user equipment, a synchronization signal according to the updated radio frequency.

At least one example embodiment provides a method for adjusting a configuration of a user equipment, the method including receiving, from a transmitter, a trigger to change a bandwidth configuration that is used as a reference for radio frequency transmit and receive requirements of the user equipment, determining whether a target bandwidth indicated by the trigger involves a change of a reference channel, configuring a radio frequency in response to determining that the target bandwidth involves the change of the reference channel, and reconfiguring the bandwidth configuration based on the trigger.

The method further includes transmitting a user equipment capability to the transmitter.

The method further includes receiving, from the transmitter, the bandwidth configuration of the user equipment, wherein the bandwidth configuration includes at least one parameter associated with the reference channel.

The reconfiguring the radio frequency may further include selecting a channel bandwidth according to the change of the bandwidth configuration, and adjusting a radio frequency location based on the channel bandwidth.

The reconfiguring the radio frequency and the reconfiguring the bandwidth configuration may be performed during a switching gap.

The method further includes receiving a synchronization signal, from the transmitter, after the switching gap.

The bandwidth configuration may be for at least one of uplink communication or downlink communication.

Reconfiguring the radio frequency further includes adjusting a radio frequency size based on the channel bandwidth.

The bandwidth configuration may include a bandwidth configuration part configuration.

The reference channel may be a reference for at least one of transmission or reception requirements for the user equipment.

Reconfiguring the bandwidth configuration further includes reconfiguring the bandwidth configuration without configuring the radio frequency in response to determining that the target bandwidth does not involve a change of the reference channel.

Reconfiguring the bandwidth in response to determining that the target bandwidth does not involve a change of the reference channel may be performed without the switching gap.

The capability may be a capability for adjusting a channel bandwidth that is used as a reference for at least one of the transmit requirement or the receive requirement.

According to at least one example embodiment, a non-transitory computer-readable storage medium may store computer-readable instructions that, when executed by one or more processors, cause a device or system to receive, from a transmitter, a trigger to change a bandwidth configuration that is used as a reference for radio frequency transmit and receive requirements of the user equipment, determine whether a target bandwidth indicated by the trigger involves a change of a reference channel, configure a radio frequency in response to determining that the target bandwidth involves the change of the reference channel, and reconfigure the bandwidth configuration based on the trigger.

According to at least one example embodiment, a method for adjusting a configuration of a user equipment includes transmitting, to the user equipment, a trigger to change a bandwidth configuration of the user equipment, receiving, from the user equipment, an updated radio frequency in response to a target bandwidth indicated by the trigger involving a change of a reference channel, and transmitting, to the user equipment, a synchronization signal according to the updated radio frequency.

Transmitting the synchronization signal includes transmitting the synchronization signal after a switching gap.

The method further includes receiving, from the user equipment, a user equipment capability.

The method further includes transmitting, to the user equipment, the bandwidth configuration of the user equipment. The bandwidth configuration includes at least one parameter associated with the reference channel.

The bandwidth configuration may be for at least one of uplink or downlink communication.

The bandwidth configuration includes a bandwidth part configuration.

The reference channel is a reference for at least one of transmission or reception requirements for the user equipment.

According to at least one example embodiment, a non-transitory computer-readable storage medium may store computer-readable instructions that, when executed by one or more processors, cause a device or system to transmit, to the user equipment, a trigger to change a bandwidth configuration of the user equipment, receive, from the user equipment, an updated radio frequency in response to a target bandwidth indicated by the trigger involving a change of a reference channel, and transmit, to the user equipment, a synchronization signal according to the updated radio frequency.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates a simplified diagram of a portion of a 3rd Generation Partnership Project New Radio access deployment for explaining example embodiments.

FIG. 2 is a block diagram illustrating an example embodiment of a gNB according to example embodiments.

FIG. 3 is a block diagram illustrating an example embodiment of a UE according to example embodiments.

FIG. 4 is an example of an interfering signal located within a channel bandwidth.

FIG. 5A is an example illustration of an interference scenario for FRMCS.

FIG. 5B is an example illustration of an interference scenario for flexible duplex.

FIG. 6 is a flowchart illustrating a method according to example embodiments.

FIG. 7 is a flowchart illustrating a method according to example embodiments.

FIG. 8 shows a signaling flow of the method shown in FIG. 7.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of radio access network (RAN) or radio network elements (e.g., a gNB), user equipment (UE), or the like, it should be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a radio network element (or user equipment) to perform the operations discussed herein.

As discussed herein the terminology “one or more” and “at least one” may be used interchangeably.

As discussed herein, a gNB may also be referred to as a base station, access point, enhanced NodeB (eNodeB), or more generally, a radio access network element, radio network element, or network node. A gNB may be implemented by a split architecture. In a split architecture, the gNB functionalities are split between a distributed unit (DU) and a central unit (CU). A split architecture may further include a relay node (e.g., integrated access and backhaul (IAB)). Some gNB functionalities may be performed by a DU portion of the IAB node. For example, the DU portion of the IAB node may facilitate (child) radio links from the DU portion to a user equipment and/or to another IAB node.

A UE may also be referred to herein as a mobile station, and may include a mobile phone, a cell phone, a smartphone, a handset, a personal digital assistant (PDA), a tablet, a laptop computer, a phablet, or the like. The UE may be implemented as a mobile termination (MT) part of the IAB node. The MT part may facilitate a parent link (e.g., backhaul link) to the serving DU.

It will be appreciated that a number of example embodiments may be used in combination.

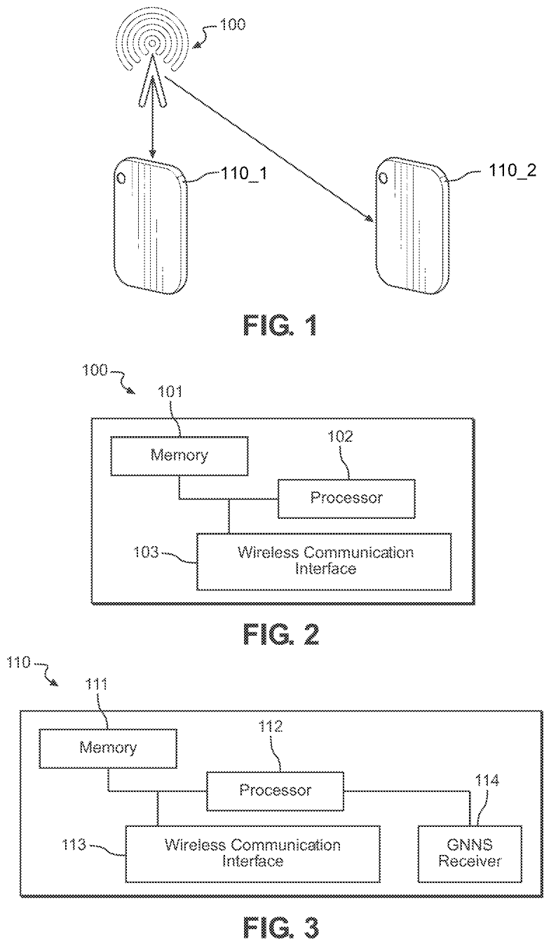

FIG. 1 illustrates a simplified diagram of a portion of a 3rd Generation Partnership Project (3GPP) New Radio (NR) access deployment for explaining example embodiments.

The portion of the 3GPP NR access deployment shown in FIG. 1 illustrates an example of two user equipments (UEs) 110_1 and 110_2 connected to a gNB 100, according to example embodiments. However, example embodiments are not limited thereto, and any number of UEs 110 may be connected to a gNB 100 at a given time.

FIG. 2 is a block diagram illustrating an example embodiment of a gNB 100 according to example embodiments.

Referring to FIG. 2, the gNB 100 may also be referred to as a base station, access point, enhanced NodeB (eNodeB), or more generally, a radio access network element, radio network element, or network node. The gNB 100 may include a memory 101, processing circuitry (such as at least one processor 102), and/or a wireless communication interface 103. The memory 101 may include various special purpose program code including computer executable instructions which may cause the gNB 100 to perform the one or more of the methods of the example embodiments. The gNB 100 may be configured to perform the gNB functions in accordance with example embodiments.

In at least one example embodiment, the processing circuitry may include at least one processor (and/or processor cores, distributed processors, networked processors, etc.), such as the at least one processor 102, which may be configured to control one or more elements of the gNB 100, and thereby cause the gNB 100 to perform various operations. The processing circuitry (e.g., the at least one processor 102, etc.) is configured to execute processes by retrieving program code (e.g., computer readable instructions) and data from the memory 101 to process them, thereby executing special purpose control and functions of the entire gNB 100. Once the special purpose program instructions are loaded into, (e.g., the at least one processor 102, etc.), the at least one processor 102 executes the special purpose program instructions, thereby transforming the at least one processor 102 into a special purpose processor.

In at least one example embodiment, the memory 101 may be a non-transitory computer-readable storage medium and may include a random access memory (RAM), a read only memory (ROM), and/or a permanent mass storage device such as a disk drive, or a solid state drive. Stored in the memory 101 is program code (i.e., computer readable instructions) related to operating the gNB 100.

FIG. 3 is a block diagram illustrating an example embodiment of a UE according to example embodiments.

Referring to FIG. 3, the UE 110 may include a memory 111, processing circuitry (such as at least one processor 112), a wireless communication interface 113, and/or a global navigation satellite system (GNNS) receiver 114. The UE 110 may be any one of, but not limited to, a mobile device, a smartphone, a tablet, a laptop computer, a desktop computer and/or the like. The UE 110 may be configured to perform the UE functions described in accordance with example embodiments.

Descriptions of the memory 111, the processor 112, and the wireless communication interface 113 may be substantially similar to the memory 101, the processor 102, and the communication interface 103, respectively, and are therefore omitted. The GNNS receiver 114 may be an interface for communicating with and/or receiving a signal from a GNNS.

Narrowband (NB) New Radio (NR) operation is an emerging scenario driven by the future of the railway communications needs (globally) as well as some smart grid operators in the United States and public safety in the European Union.

NR support for dedicated spectrum less than 5 MHz extends 5G services to certain specialized vertical use cases and in dedicated spectrum bandwidths below 5 MHz. The Future Railway Mobile Communication System (FRMCS) will use NR and may replace global system for mobile communications (GSM) railway (GSM-R).

Soft migration from GSM-R to FRMCS will necessitate co-existence of GSM-R and NR within 2×5.6 MHz of FDD spectrum, leaving approximately 3.6 MHz for NR operation. This scenario is challenging from a coexistence point of view since user equipments (UEs) are expected to operate according to a 5 MHz channel bandwidth.

Flexible duplexing is another emerging scenario in the future deployment of Rel-18. Rel-18 may contain only study items related to flexible duplexing, while the work items (e.g., introducing corresponding normative specifications) may be included in Rel-19. In flexible duplexing, duplex enhancement takes place at the gNB 100. The gNB 100 transmits and receives simultaneously via a same time division duplex (TDD) carrier (e.g., Tx and Rx are frequency division multiplexed (FDM'ed) within the same carrier). A half-duplex operation is performed at the UE 110. There is no restriction on frequency ranges.

When considering challenging co-channel and/or adjacent channel scenarios (such as FRMCS or flexible duplexing), there may be mutual interference between a desired (NR) signal and at least one interfering signal.

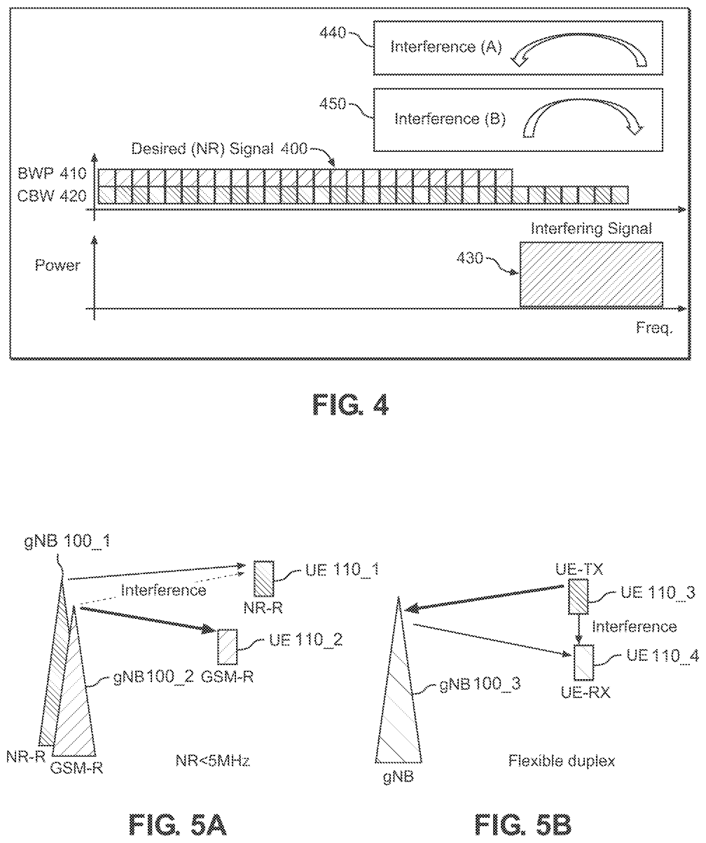

FIG. 4 is an example of an interfering signal located within a channel bandwidth.

When considering challenging co-channel and/or adjacent channel scenarios (such as FRMCS scenario or flexible duplex), there may be mutual interference between a desired (NR) signal and at least one interfering signal.

Referring to FIG. 4, a desired signal 400 may include a channel bandwidth (CBW) 410 and a bandwidth part (BWP) 420.

The BWP 420 is a contiguous set of physical resource blocks selected from a contiguous subset of common resource blocks for a given numerology on a given carrier. The BWP 420 may be defined separately for uplink (UL) and downlink (DL). A UE may be configured with multiple BWPs (e.g., multiple BWPs for both UL and DL). However, only one BWP can be active at a given point in time.

The CBW 410 relates to an NR RF carrier in UL or DL. The CBW 410 has a predefined (or alternately given) BW (e.g., 5, 10, 20, . . . , 100 MHz). The CBW is located at a predefined (or alternately given) location in the channel raster. The CBW includes a predefined (or alternately given) guard band (e.g., minimum guard band) with regard to a channel edge.

As shown in FIG. 4, an interfering signal 430 may be transmitted on a frequency that does not overlap in frequency with the BWP, but does overlap with the upper RBs of the CBW. The interfering signal 430 may cause interference A 440, as shown in FIG. 4. Interference A 440, shown in FIG. 4, is GSM-R interference to NR (e.g., GSM-R interference experience by a UE operating according to NR). A UE operating according to NR may experience the interference A 440 as interfering with NR reception. Interference A 440 may be mitigated by, for example, Rx filtering at the UE 110.

Interference B 450, shown in FIG. 4, is NR interference to GSM-R. A UE 110 operating according to GSM-R may experience the interference B 450 as interfering NR transmission. Interference B 450 may be mitigated by, for example, Tx filtering at the gNB 100.

FIG. 5A is an example illustration of an interference scenario for FRMCS.

Referring to FIG. 5A, during a soft migration from GSM-R to NR-R (e.g., FRMCS), both gNBs 100 and UEs 110 using GSM-R and gNBs 100 and UEs 110 using NR-R may be operating at the same time on the same frequency band (such as n100 covering 5.6 MHz BW), FDM'ed with each other. FIG. 5A illustrates a gNB 100_1 and a UE 110_1 operating using GSM-R, and a gNB 100_2 and a UE 110_2 operating using NR-R. In this scenario, as shown in FIG. 5A, a portion of a signal (such as spurious emissions) transmitted to the UE 110_2 may be received by the UE 110_1.

NR-R uses a more robust 3 MHz CBW compared with GSM-R, but has a considerably smaller data rate (e.g., 20% less). In this case, NR transmission and/or NR reception operates according to 3 MHz RF. In contrast the example shown in FIG. 4 operates according to 5 MHz RF. For NR-R operating according to 3 MHz RF, RF filtering may effectively filter both reception interference (e.g., Interference A 440) and transmission interference (e.g., Interference B 450).

According to example embodiments, it may be beneficial to vary radio frequency (RF) settings for DL BWP according to an actual (or real-time) interference scenario to reduce an occurrence of interference between GSM-R and FRMCS. This may result in a faster adaptation when compared with changing the CBW. However, currently, NR does not allow dynamic adaptation of the UE RF bandwidth (BW) in real time according to a varying interference scenario.

FIG. 5B is an example illustration of an interference scenario for flexible duplex.

Referring to FIG. 5B, UE RF may be configured according to CBW in a flexible duplex network. Accordingly, as shown in FIG. 5B, UE-to-UE interference between a transmitting UE-TX UE 110_3 and a receiving UE-RX UE 110_4, both communicating with gNB 100_3, may occur.

BWP switching can be applied to dynamically change the baseband resource pool. However, BWP switching does not mandate a bandwidth change for the UE RF. Therefore, as UE RF coexistence requirements (e.g., spurious emission and receiver blocking) are specified based on the CBW instead of the BWP, UE-to-UE interference, such as shown in FIG. 5B, may occur. In other words, the transmitting NR UE 110_3 may create interference (such as spurious emissions) to the receiving NR UE 110_4 at that same time on the neighboring RBs.

According to example embodiments, when flexible duplex is not applied (by the gNB) it would be beneficial for UEs to operate according to wide RF BW to increase or maximize the achievable data rate.

In some cases, CBW may be allocated for only one of UL or DL (e.g., half-duplex). In these cases, the UE RF may operate according to full (e.g., wide) CBW to increase or maximize data rate in the UL or DL. However, for in the case of flexible duplexing (e.g., the gNB operates according to both UL and DL), it may be beneficial for the UE to narrow the RF BW according to actual UL and/or DL depending on which link direction the UE is operating in.

Currently, UE RF BW is determined by a minimum of the network carrier or a BW defined by UE capability (e.g., in the case of RedCap). The network carrier is configured by means of SCS-SpecificCarrier. In this configuration, the UE RF may be determined according to a SCS specific network carrier. In this case, an RF requirement for a BWP is defined by the CBW. The UE RF configuration is left for UE implementation.

According to example embodiments, a UE 110 may define a BWP configuration for the UE 110 where a UE RF size and/or location is determined according to an available resource block (RB) grid and an associated reference CBW. As used herein, the term location may refer to a starting frequency of a frequency range. The location may be defined such that there is enough guard band with regard to channel edges and/or such that the location is aligned with a predefined (or alternately given) channel raster. Valid channel raster points are defined, for example, in 3GPP TS 38.104 (TS 38.104) Table 5.4.2.3-1. This mode of operation may be referred to as RF BWP.

Each RF BWP has a reference CBW. The reference CBW may be selected as part of the RF BWP configuration. For example, for current (e.g., Rel-17) BWPs, the reference CBW may be equal to the CBW. For other (e.g., Rel-18) BWPs, the reference CBW can be selected from CBW options which support a given number of RBs configured for a given subcarrier spacing. In one example embodiment, the UE RF (e.g., reference CBW) may be set according to a next highest CBW value after the BWP bandwidth.

For example, a RF BWP is configured with 30 kHz SCS, and 50 RBs. In this case, valid configuration options for reference CBW would be [20 25 30 40 50 60 70 80 90 100] MHz (RB≥50), while invalid configuration options for reference CBW would be [5 10 15] MHz (RB<50). The second configuration is invalid because the CBW for 15 MHz and below does not contain enough RBs. Upper limits for different subcarrier spacings and CBWs are listed in 3GPP Technical Specification TS 38.101-1 (TS 38.101-1) incorporated herein by reference in its entirety.

According to example embodiments, the RF BWP can be defined for uplink (UL) only, downlink (DL) only, or both UL and DL.

When a UE 110 is configured to operate according to RF BWP, according to example embodiments, the UE 110 determines at least one requirement (e.g., RF, Demod, etc.) for transmission and/or reception based on the associated reference CBW instead of the CBW.

For example, the UE 110 may determine a maximum number of RBs (NRB) according to the reference CBW instead of the CBW. This example may occur, for example, when defining the RB region (edge/outer/inner) for maximum power reduction (MPR). MPR defines an allowed reduction of a maximum power level for certain combinations of modulations used and a number of resource blocks that are assigned. MPR is typically defined with regard to the maximum output power for a UE power class.

According to example embodiments, the UE 110 may switch between the RF BWP and a current BWP (defined according to SCS-SpecificCarrier) according to current BWP switching mechanisms. Switching may be performed in both directions. For example, the UE 110 may switch from a current BWP (e.g., initial BWP) to the RF BWP. In another example, the UE 110 may switch from the RF BWP to the current BWP (e.g., the initial BWP). As a result of the switching an active BWP of the UE 110 changes from the current BWP to a target BWP. Current switching times (e.g., according to Table 8.6.2-1 in 3GPP Technical Specification TS 38.133 (TS 38.133), the entire contents of which are incorporated herein by reference) can be applied when switching does not involve a change in the reference CBW.

According to example embodiments, switching may be triggered by downlink control information (DCI) and/or by timer. Additionally, switching may be triggered according to semi-static adaptation for BWPs (including RF BWPs). This can be beneficial especially in flexible duplex or other similar scenarios where the co-channel interference conditions vary in a deterministic manner. Semi-static adaptation may at least partially follow the predefined (or alternately given) slot formats (e.g., Fixed duplex (UL, DL, Flexible), vs. Flexible Duplex)).

According to example embodiments, switching between BWPs having different reference CBWs may involve RF tuning (e.g., RF configuration changes). For example, the UE 110 may change the RF configuration if the UE 110 switches between a first RF BWP with a reference CBW equal to 5 MHz and a second RF BWP with a reference CBW equal to 3 MHz.

For a current BWP, the UE 110 may determine the RF BWP according to the CBW. Alternatively, the UE 110 may determine the RF BWP for the current BWP according to a bandwidth of an initial BWP.

When the switching between BWPs involves change of the reference CBW, the UE 110 redefines the switching times. For example, based on (inter-frequency) measurement gap design, the UE 110 may determine that an additional 0.5 ms on top of the BWP switching time is sufficient. Alternatively, the UE 110 may define switching times according to a UE-specific CBW change delay (e.g., 3GPP Technical Specification TS 38.331 (TS 38.331), Section 8.13.2). However, example embodiments are not limited thereto, and the UE 110 may define switching times according to any known method.

The UE 110 may assume that the first DL slot(s) received from the gNB 100 (after switching) contains a signal (such as TRS) that can be used for time/frequency synchronization.

According to example embodiments, the UE 110 may select an RF location for the RF BWP such that both ends of the BWP contains at least an x MHz guard band (e.g., minimum guard band), where x is defined based on a guard band size of the associated reference CBW according to 3GPP Technical Specification TS 38.101-1 (TS 38.101-1) or 3GPP Technical Specification TS 38.101-2 (TS 38.101-2), each of which is incorporated herein by reference (e.g., according to Table 5.3.3-1 in TS 38.101-1).

According to example embodiments, the UE 110 determines the RF size and location such that both sides of the RF BWP contain at least y % of the guard band around the available RB grid. The available RF grid may be determined based on a common RF grid which covers the whole CBW. The common RB grid is a function of subcarrier spacing. The available RF grid may be based on the common RB grid and the BWP. Each BWP is a subset of the common RB grid with a predefined (or alternately given) starting RB and ending RB. For example, y may be a function of bandwidth utilization (%) on the reference CBW. y may be, for example, 5%. y may be chosen such that the RF is substantially “middle” in the reference CBW (e.g., the RF carrier contains unused guard bands at carrier edges).

According to example embodiments, the BWP configuration (e.g., BWP config in TS 38.331, and RAN4 spaces) is extended to support operations according to RF BWP. For example, BWP-DownlinkDedicated may be extended to support configuration for the Reference CBW.

According to example embodiments, a BWP may be implicitly mapped to a Reference CBW according to at least one of its parameter (e.g., locationAndBandwidth IE). Additionally BWP-UplinkDedicated IE may be extended to enable UL configuration separately. Alternatively, BWP IE may be extended to support configuration of the reference CBW.

According to example embodiments, the extension could alternatively be achieved, for example, by including SCS-SpecificCarrier IE to the indented information element, or a new element could be introduced providing the CBW.

According to example embodiments, the UE 110 may adjust the RF location according to definitions for how to adjust the RF location and which RF requirements to follow (e.g., according to reference CBW, and not according to CBW) included in RAN4 RF specifications (such as TS 38.101-1).

According to example embodiments, the UE 110 may define switching times according to a definition for the BWP switching times included in RAN4 RRM specifications (such as TS 38.133) for the cases where the Reference CBW changes.

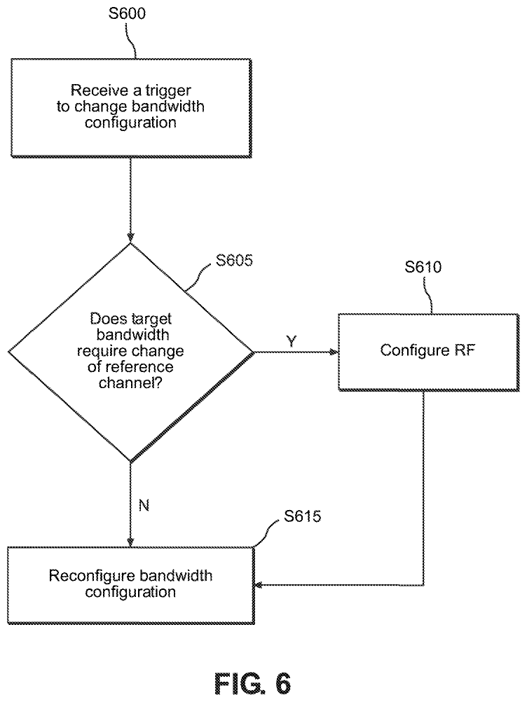

FIG. 6 is a flowchart illustrating a method according to example embodiments.

Referring to FIG. 6, at step S600, the UE 110 receives a trigger, from the gNB 100, to change a bandwidth configuration that is used as a reference for RF transmission and reception with the gNB 100. For example, the trigger may indicate a change in the BWP. The trigger may be received, for example, via radio resource configuration (RRC) or with DCI. For example, the gNB 100 may transmit the trigger in response to a change of an interference scenario (e.g., more or less GSM-R traffic), in response to a change between CBW allocation for half-duplexing to CBW allocation for flexible duplexing (or vice versa), etc. The trigger may be transmitted via a DCI, a MAC, a RRC, etc. The gNB 100 may leverage existing signaling used for BWP changes for sending the trigger.

At step S605, the UE 110 determines whether a target BWP, included in the trigger, requires a change of a reference CBW. The reference CBW may be selected as part of the RF BWP configuration. For example, for current (e.g., Rel-17) BWPs, the reference CBW may be equal to the CBW. For other (e.g., Rel-18) BWPs, the reference CBW can be selected from CBW options which support a given number of RBs configured for a given subcarrier spacing.

If the UE 110 determines that the target BWP requires a change of the reference CBW (Y at step S605), then at step S610, the UE 110 configures an RF front end based on the new reference CBW. For example, the UE 110 may set an RF BW location and size according to a BW associated with the reference CBW. The UE 110 then proceeds to step S615.

Returning to Step S605, if the UE 110 determines that the target BWP does not require a change of reference CBW (N at step S605), then the UE 110 proceeds to step S615.

At step S615, the UE 110 reconfigures its BWP based on the reference CBW.

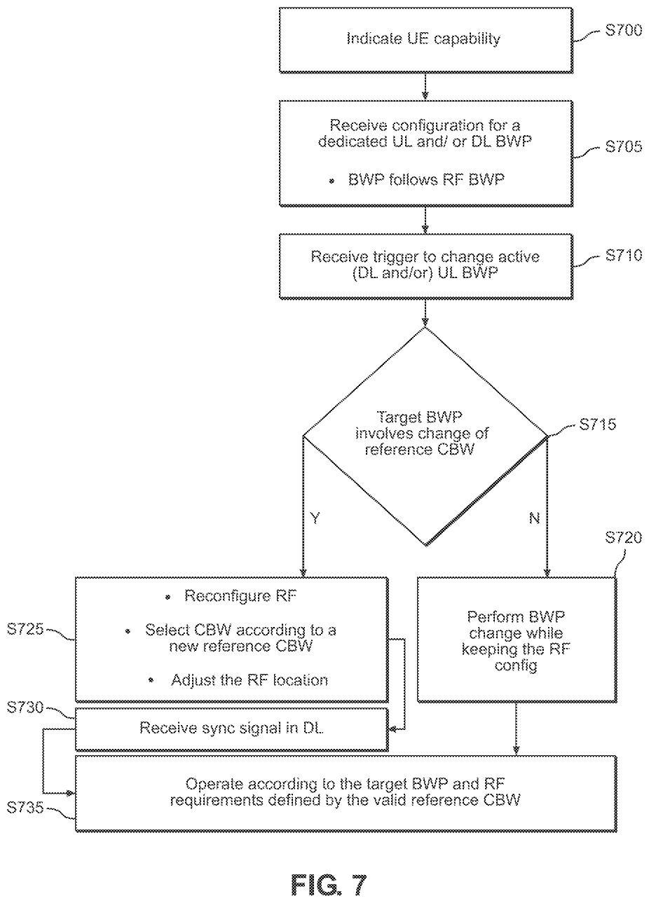

FIG. 7 is a flowchart illustrating a method according to example embodiments.

Referring to FIG. 7, at step S700 the UE 110 indicates a UE capability to the gNB 100. For example, the UE 110 may transmit a UE capability with regard to an RF BWP to the gNB 100. The UE 110 may act according to legacy capabilities during initial access to the gNB 100. When an RRC connection has been established, the UE 110 may transmit the UE capability (e.g., via a RRC message indicating the capability) to the gNB 100.

Alternatively, the gNB 100 may determine the capability information of the UE 110 from some other information. For example, the UE 110 may indicate that the UE 110 operates according to Rel-18. The gNB 100 may determine that the UE 110 supports RF BWP based on the UE 110 operating according to Rel-18.

In another example, all UEs may support RF BWP (e.g., in 6G). In this case, step S700 may be omitted.

According to example embodiments, a BWP can be implicitly mapped to a Reference CBW according to at least one parameter of the BWP.

At step S705, the UE 110 receives, from the gNB 100, a configuration (e.g., a RRC) for a dedicated UL and/or DL BWP. According to example embodiments, the BWP may be associated with, or follow, a RF BWP. The RRC configuration includes DL and/or UL BWPs and RF BWs corresponding to the BWPs. The RRC may include at least one parameter associated with the reference CBW. The UE 110 sets a configuration of the BWP according to the received RRC configuration.

At step S710, the UE 110 receives, from the gNB 100, a trigger to change an active BWP for the DL and/or UL between the UE 110 and the gNB 100.

At step S715, the UE 110 determines whether changing to the target BWP involves a change of a reference CBW. The reference CBW may be a configuration parameter associated with the BWP. The UE 110 may determine whether a reference CBW associated with the target BWP is different from a reference CBW associated with a current BWP of the UE 110.

If changing the active BWP to the target BWP does not involve a change of the reference CBW (N at step S715), then the UE 110 proceeds to step S720.

At step S720, the UE 110 changes the active BWP to the target BWP, and does not alter an RF configuration. In this case, the UE 110 may change to the target BWP without a switching gap. The UE 110 then proceeds to step S735.

Returning to step S715, if the UE 110 determines that changing to the target BWP does involve a change of the reference CBW (Y at step S715), then the UE 110 proceeds to step S725.

At step S725, the UE 110 changes the active BWP to the target BWP, and reconfigures the RF configuration. To reconfigure the RF configuration, the UE 110 determines a new reference CBW according to the target BWP. The UE 110 selects a CBW according to the new Reference CBW. The UE 110 then adjusts an RF location based on the selected CBW. For example, the UE 110 may set an RF BW location and size according to a BW associated with the reference CBW.

There may be a break in communication between the UE 110 and the gNB 100 during the change to the target BWP. The break in communication may be referred to as a switching gap. The UE 110 may transmit a signal to the gNB 100 indicating a start of the switching gap before the break in communication. After the UE 110 changes to the target BWP, the UE 110 may transmit a signal indicating an end of the switching gap and to resume communication. Alternatively, the switching gap duration may de determined based on specification. For example, the starting time for the switching gap may be determined based on the trigger indicating the BWP switching.

At step S730, after the switching gap, the UE 110 receives, from the gNB 110, a synchronization signal in the DL for synchronizing communication between the UE 110 and the gNB 100 after the switching gap. The UE 110 may synchronize communication with the gNB 100 according to the synchronization signal. For example, the UE 110 may perform time and/or frequency synchronization based on the synchronization signal. The UE 110 may perform a resynchronization with the gNB 100 when the RF configuration is changed.

At step S735, the UE 110 operates according to the target BWP and the RF configuration.

Example embodiments address difficult coexistence situations (e.g., with GSM, flexible duplex, and/or NR<5 MHz). According to example embodiments, because the RF configuration is based on the Reference CBW, a gNB may reduce or minimize co-channel and/or adjacent channel interference while controlling the need for a UE's RF retuning and/or the associated switching gaps. For example, according to example embodiments, the gNB may have a better understanding about a UE's RF location while providing the UE with increased or sufficient implementation flexibility. Therefore, both UL and DL operation of the UE may be improved.

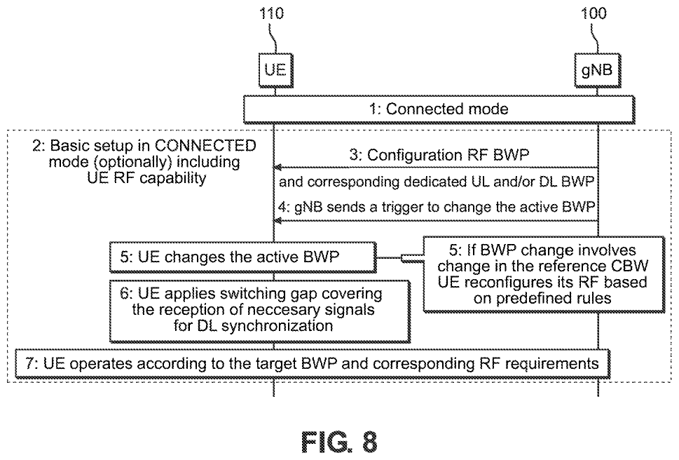

FIG. 8 shows a signaling flow of the method shown in FIG. 7.

The operations shown in FIG. 8 may be substantially similar to operations described with regard to FIG. 7. Descriptions of such operations are therefore omitted.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the preceding description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment, base stations, eNB s, RRHs, gNB s, femto base stations, network controllers, computers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, base stations, eNB s, RRHs, gNBs, femto base stations, network controllers, computers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

What is claimed is:

1. A device, comprising:
a memory; and
processing circuitry configured to cause the device to:
receive, from a network node, a trigger to change a bandwidth configuration that is used as a reference for radio frequency transmission and reception requirements of the device,
determine whether a target bandwidth indicated by the trigger involves a change of a reference channel,
configure a radio frequency in response to determining that the target bandwidth involves the change of the reference channel, and
reconfigure the bandwidth configuration based on the trigger.

2. The device of claim 1, wherein the processing circuitry is further configured to cause the device to transmit a user equipment capability to the network node.

3. The device of claim 2, wherein the capability is a capability for adjusting a channel bandwidth that is used as a reference for at least one of the transmit or the receive requirements.

4. The device of claim 1, wherein the processing circuitry is further configured to cause the device to:
receive, from the network node, the bandwidth configuration of the device,
wherein the bandwidth configuration includes at least one parameter associated with the reference channel.

5. The device of claim 1, wherein the processing circuitry is further configured to cause the device to reconfigure the radio frequency by:
selecting a channel bandwidth according to the change of the bandwidth configuration; and
adjusting a radio frequency location based on the channel bandwidth.

6. The device of claim 5, wherein the processing circuitry is further configured to cause the device to adjust a radio frequency size based on the channel bandwidth.

7. The device of claim 1, wherein the processing circuitry is further configured to:
cause the device to reconfigure the radio frequency and reconfigure the bandwidth configuration during a switching gap; and
receive a synchronization signal, from the network node, after the switching gap.

8. The device of claim 1, wherein the bandwidth configuration is for at least one of uplink or downlink communication.

9. The device of claim 1, wherein the bandwidth configuration includes a bandwidth part configuration.

10. The device of claim 1, wherein the reference channel is a reference for at least one of transmission or reception requirements for the device.

11. A device comprising:
a memory; and
processing circuitry configured to cause the device to
transmit, to a user equipment, a trigger to change a bandwidth configuration of the user equipment;
receive, from the user equipment, an updated radio frequency in response to a target bandwidth indicated by the trigger involving a change of a reference channel; and
transmit, to the user equipment, a synchronization signal according to the updated radio frequency.

12. The device of claim 11, wherein the processing circuitry is further configured to cause the device to transmit the synchronization signal after a switching gap.

13. The device of claim 11, wherein the processing circuitry is further configured to cause the device to receive a user equipment capability from the user equipment.

14. The device of claim 11, wherein the processing circuitry is further configured to cause the device to transmit, to the user equipment, the bandwidth configuration of the user equipment,
wherein the bandwidth configuration includes at least one parameter associated with the reference channel.

15. The device of claim 11, wherein the bandwidth configuration is for at least one of uplink or downlink communication.

16. The device of claim 11, wherein the bandwidth configuration includes a bandwidth part configuration.

17. The device of claim 11, wherein the reference channel is a reference for at least one of transmission or reception requirements for the user equipment.

18. A method for adjusting a configuration of a user equipment, the method comprising:
receiving, from a network node, a trigger to change a bandwidth configuration that is used as a reference for radio frequency transmit and receive requirements of the user equipment;
determining whether a target bandwidth indicated by the trigger involves a change of a reference channel, configuring a radio frequency in response to determining that the target bandwidth involves the change of the reference channel; and
reconfiguring the bandwidth configuration based on the trigger.

19. The method of claim 18, further comprising:
selecting a channel bandwidth according to the change of the bandwidth configuration; and
adjusting a radio frequency location based on the channel bandwidth.

20. The method of claim 19, wherein the processing circuitry is further configured to cause the device to adjust a radio frequency size based on the channel bandwidth.
